(19) United States
(12) Patent Application Publication
(10) Pub. No.: US 2008/0125970 A1
(43) Pub. Date: May 29, 2008

(54) Traffic safety pylon with GPS locating and RF signalling

(75) Inventor: Ross D. Scheckler, Cato, NY (US)

Correspondence Address: BERNHARD P. MOLLDREM, JR., 224 HARRISON STREET, SUITE 200, SYRACUSE, NY, 13202, US

(73) Assignee: Calmar Holdings, LLC.

(21) Appl. No.: 11/606,317

(22) Filed: Nov. 28, 2006

(51) Int. Cl. G01C 21/02

(52) U.S. Cl. 701/213

(57) ABSTRACT

An intelligent traffic safety cone or pylon is placed in a traffic lane of a roadway to mark the beginning or end of a roadway traffic obstruction. The pylon has a GPS sensor disposed at the top of the body portion that rises from the pylon base. A battery is situated within the pylon base providing stabilizing weight. A microprocessor circuit within the pylon body is coupled to the GPS sensor to acquire location data of said pylon to within a resolution of a lane of the roadway. A radio transmitter within the pylon body coupled to the microprocessor provides a radio signal modulated to provide the location data to a central traffic navigation facility. The pylon may have a folding antenna, and may have additional sensors for traffic conditions and weather conditions.

### BACKGROUND OF THE INVENTION

This invention relates to traffic safety, and to remote monitoring of roadway traffic conditions. The invention is more particularly concerned with an intelligent traffic cone or pylon, which can be placed at one end of a roadway obstruction or traffic delay, such as a road construction or repair, and which can communicate its location and other information to a central traffic navigation facility.

Traffic safety cones or pylons and other typical traffic safety barriers can typically be lightweight, highly visible articles used to mark a traffic obstruction. These typically are passive devices which employ reflective tape for increased visibility and in some cases may include a lamp, flashers, or the like. However, to date there have been no traffic safety cones that incorporate means for automatically identifying the cone and its specific geographical location, and for automatically communicating that information to a central facility.

It is desirable to facilitate the operation of motor freight carriers, i.e., those employing tractor-trailers or other trucks that proceed along public thoroughfares. Such a system can involve gathering roadway repair and construction data, as well as traffic density data, for large geographical areas, and then providing such data to a central facility where it can be communicated to the freight operators. Accurate knowledge of road conditions, including points along the traffic lanes that may be obstructed or under construction, is useful in the efficient and timely transport and delivery of freight by these carriers. Traffic density, weather, and other conditions, if known, can also be useful for the freight carrier. However, these data typically have to be keyed in manually, which can lead to time lags between commencement of a traffic delay and the appearance of the relevant data on the roadway navigation service. Also, real time traffic flow information, such as traffic density, average traffic speed, weather conditions, for given points along the roadway, are difficult or impossible to obtain, and these data are difficult to update and maintain. No one has proposed any effective technique for real-time or near-real-time updates of traffic data of this nature.

### OBJECTS AND SUMMARY OF THE INVENTION

Accordingly, it is an object of the present invention to provide a process for providing motor vehicle operators with real-time status of roadway conditions, including the locations of obstructions, blockages and outages, in a way that avoids the drawbacks of the prior art.

It is a more particular object to provide a roadway traffic safety cone or pylon which automatically finds its geographical position, and then signals that information to a central facility, where the data are transmitted to the motor vehicle operators, to identify the locations and nature of traffic obstructions or roadway outages.

Another object is to provide such a pylon that can be easily set out by a road crew at one or both ends of a section of roadway or a traffic lane, and can be easily picked up at the end of construction for use elsewhere or for storage.

In accordance with one aspect of the present invention, a roadway cone or traffic safety pylon has a bottom or base and a body that rises upwards from the base. There is a rechargeable battery in the base of the pylon, which both provides energy for the electronic circuitry within it, and also serves as a ballast or stabilizing weight for the device.

The pylon has a GPS sensor at its top, a microprocessor circuit within the body of the pylon, and a radio transmitter in the pylon body. The microprocessor circuit is coupled to the GPS sensor to acquire location data for the pylon. These data are obtained with a resolution of about five feet (one and one-half meters) or less, i.e., within about one half the width of a traffic lane. The microprocessor is coupled to the transmitter, and the latter provides a radio signal that is modulated with the traffic location data. This signal is fed to an antenna mounted on the pylon body and the signal is sent to a receiver for a central traffic navigation facility. Other information can be detected and sent on the radio signal as well, e.g., traffic density, average traffic speed, temperature, rainfall, or other weather data. The central facility obtains accurate locations for each of the pylons that are set out, and is able to identify the commencement and termination of each traffic obstruction, which may be a traffic accident site, or a segment of a roadway lane under construction or repair, for example. The central facility then processes these data, and provides accurate navigation data wirelessly to motor freight operators and/or other motor vehicle operators which are equipped with an in-cab navigation system. The data can also be sent via wireless or landline means to the carrier's dispatch office and/or to police departments and traffic patrols.

The pylons are easily set out by road construction or repair crews, or by highway patrol or other public safety officers, and can be easily turned on. Once this is done, each traffic cone or pylon obtains its location via its GPS circuitry, and then communicates its identification and its location to the central traffic navigation facility. These pylons update their status on a regular basis, e.g., each several minutes or each hour, so that the central facility is continually apprised of the status of each identified roadway obstruction or hazard.

The units operate at low power, so that they may be left in continuous operation at a site for protracted lengths of time, e.g. a week or more. The traffic density and traffic speed sensing can be done using passive techniques, e.g., audible sensing of vehicles, and Doppler sensing of the passing vehicles.

The above and many other objects, features, and advantages of this invention will be more fully appreciated from the ensuing description of a preferred embodiment, which is to be read in conjunction with the accompanying Drawing.

### BRIEF DESCRIPTION OF THE DRAWINGS

FIG. 1 is a perspective view of a traffic safety pylon according to one possible embodiment of the invention.

FIG. 2 is an elevation thereof, partly in ghost to illustrate internal components.

FIG. 3 is a schematic diagram of the traffic navigation assistance system employing the cones or pylons of this invention.

### DETAILED DESCRIPTION OF THE PREFERRED EMBODIMENT

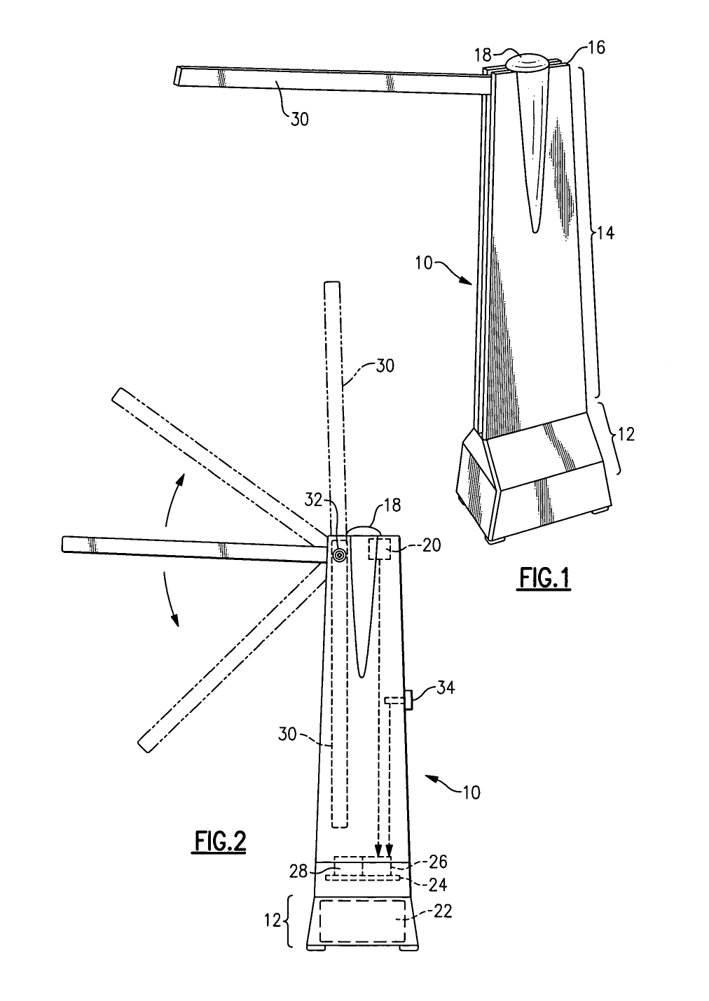

With reference now to the Drawing, FIG. 1 shows a traffic safety pylon 10 or traffic cone, which has a base 12 at its lower end for resting on a roadway surface, and a body portion 14 that rises upward from the base 12 to a top 16. Within a dome 18 at the top is located a GPS receiver 20 (see FIG. 2). Placed here at the dome 18, the GPS receiver 20 will have the best view of the sky to receive the navigation signals from a constellation of navigation satellites. As the satellites orbit past again and again, the location information for the pylon becomes more and more fine-tuned, i.e., the accuracy of the data becomes better. The resolution of the location data in a short while reaches about one-half the width of a lane of traffic. This allows the pylon 10 to identify fairly precisely the end of the traffic lane where it has been placed, and to identify the specific lane of a multi-lane highway where the traffic obstruction exists.

A battery 22 is mounted within the base 12 of the pylon. This may be a lead-acid battery providing sufficient power to the pylon for a period of a week or more of continuous service, and also providing a stabilizing weight to the base of the pylon. As the entire pylon may weigh as much as forty pounds, the weight of the battery 22 alone may be thirty pounds.

A circuit board 24 is disposed within the pylon body 14 and has a microprocessor circuit 26 connected with the GPS receiver 20. This microprocessor contains program code and memory capacity to capture and store the GPS data, as well such as weather data and/or traffic data. The microprocessor then encodes the data and sends it to a low-power radio transmitter 28 connected with the microprocessor circuit 26. This transmitter 28 provides a modulated RF signal to a swing-out antenna 30 pivotally mounted to the top of the pylon.

The antenna 30 here is pivoted on a pivot member 32 at the top 16 of the cone or pylon, and can be raised to the vertical position as shown when the pylon is placed at the road site, and lowered to a storage position within the pylon body 14 when the pylon is picked up and retrieved at the end of a construction job. This pivot member 32 includes a switch to turn the pylon electronics ON when the antenna is rotated up, and OFF when the antenna is rotated back to its storage position. In other embodiments, an antenna can be a multi-section folding antenna, or can be a whip type antenna or long wire antenna.

Also shown in mounted on the pylon body 14 is an audio sensor 34, which is employed to pick up the sounds of vehicles passing the work site or obstruction where the pylon 10 is located. The microprocessor circuit 26 can analyze the signal picked up by this sensor and determine the number of vehicles per minute and by analyzing frequency differentials or Doppler shifting in the traffic sounds can also provide a measure of average traffic speed at the site.

In addition, a temperature sensor, rainfall sensor, and/or other sensor can be included and coupled to the microprocessor circuit 26, to provide telemetry to the central navigation facility of weather data at the site of the traffic obstruction.

The availability of traffic density, speed, and weather information at these locations is often useful to public safety agencies, such as local or state police, to ensure patrols are dispatched in case a potential traffic safety situation arises.

While not shown here, there may be a switch mounted with the antenna 30 so that it turns the pylon electronics on when the antenna is swung out to the raised position, and turns them off when the antenna 30 is returned to the folded down position within the pylon body.

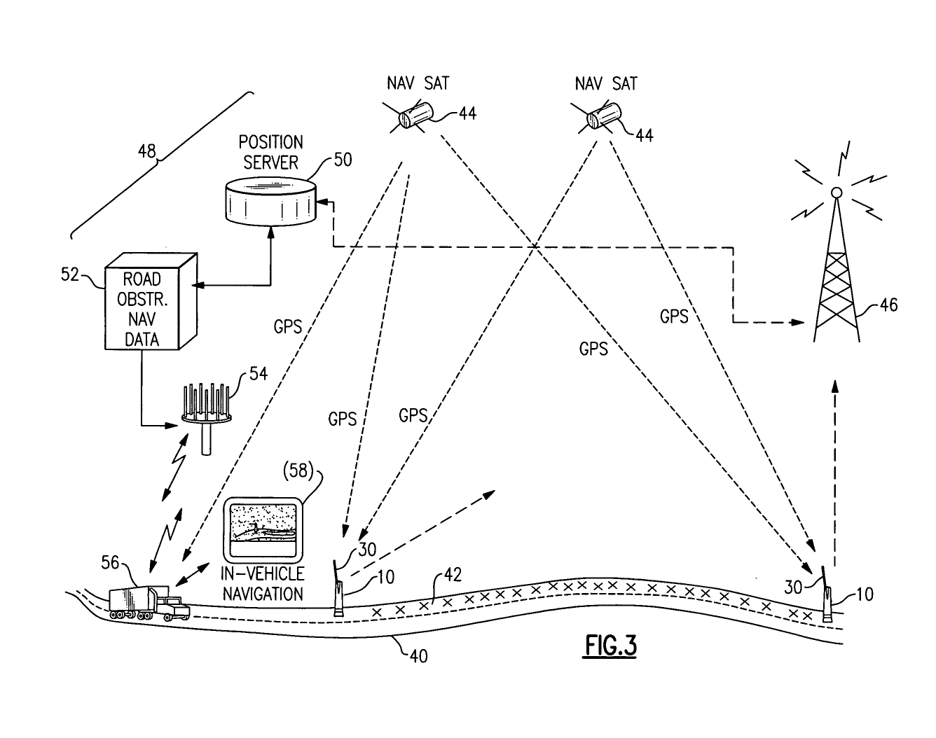

FIG. 3 is a schematic system diagram to illustrate how the traffic pylons 10 of this invention can be used in an overall highway navigation assistance system. As shown schematically, a roadway 40 has a pair of the intelligent traffic cones or pylons 10, 10 marking the beginning and end of a traffic obstruction 42, here indicated graphically by a series of “X”s, and which occur in a single traffic lane of the highway 40. This obstruction 42 may be the location of a road construction or repair crew. The pylons each have a view of a constellation of navigation satellites 44, 44, and can thus obtain accurate geographic location data of sufficient resolution so that the obstructed lane is identified. The location data, plus weather and traffic data, are communicated via the radio frequency carrier from the intelligent pylons 10, 10 to a radio receiver 46 at a radio receiving site. The location data and other data from the respective pylons are then communicated to the central roadway navigation facility 48. At this facility, these data are accumulated on a position server 50. The data are coordinated in a road obstruction mapping computer 52, which provides constantly updated navigation information to motorists such as motor freight operators who may subscribe to the system or otherwise have access to it. In this case, the data are communicated over a wireless network, represented here with a cell phone tower 54, to vehicles such as the commercial freight-hauler truck 56 as shown proceeding along the roadway 40. This truck 56 is equipped with in-vehicle navigation instrumentation, which receives the data wirelessly from the facility 48, and which also obtains its own geographical location, e.g., with GPS equipment that receives signals from the satellites 44, 44. The road conditions, including information about any en-route obstructions such as accident sites and construction sites, can then be displayed on a screen 58 in the vehicle cab.

While the invention has been described with reference to a specific preferred embodiment, the invention is certainly not limited to that precise embodiment. Rather, many modifications and variations will become apparent to persons of skill in the art without departure from the scope and spirit of this invention, as defined in the appended claims.

I claim:

1. A traffic safety pylon adapted to be used with an intelligent roadway navigation system, the pylon being adapted to be placed in a traffic lane of a roadway to mark the beginning or end of a roadway traffic obstruction; the pylon comprising
a base;
a body rising up from the base to a top;
a GPS sensor disposed at said top;
a battery situated in said base providing stabilizing weight to said pylon;
a microprocessor circuit within the pylon body and coupled to said GPS sensor to acquire location data of said pylon to within a resolution of a width of said traffic lane;
a radio transmitter in said pylon body coupled to said microprocessor and providing a radio signal modulated to provide said location data to a central traffic navigation facility; and
an antenna coupled to said transmitter and mounted on said pylon body.

2. Traffic safety pylon according to claim 1 wherein said antenna folds out from a storage position concealed within said body to a raised operative position.

3. Traffic safety pylon according to claim 2 wherein said antenna includes switch means for turning the pylon microprocessor circuit and radio transmitter on when the antenna is moved to its raised position and off when the antenna is moved to is storage position.

4. Traffic safety pylon according to claim 1, further comprising a vehicle traffic sensor mounted on said body for detecting density of vehicular traffic at said roadway traffic obstruction.

5. Traffic safety pylon according to claim 1, further comprising a vehicle traffic sensor mounted on said body for detecting average speed of vehicular traffic at said roadway traffic obstruction.

6. Traffic safety pylon according to claim 1, further comprising a weather condition sensor mounted on said body for detecting one or more weather parameters at said roadway traffic obstruction.
